(19) United States
(12) Patent Application Publication
(10) Pub. No.: US 2017/0052525 A1
(43) Pub. Date: Feb. 23, 2017

(54) OBJECT ARRANGEMENT APPARATUS

(71) Applicant: FUJI XEROX CO., LTD., Tokyo (JP)

(72) Inventors: Masanori YOSHIZUKA, Kanagawa (JP); Toshihiro NUMAUCHI, Kanagawa (JP)

(73) Assignee: FUJI XEROX CO., LTD., Tokyo (JP)

(21) Appl. No.: 15/057,531

(22) Filed: Mar. 1, 2016

(30) Foreign Application Priority Data
Aug. 20, 2015 (JP) 2015-162378

(51) Int. Cl. G05B 19/402; B21D 28/06

(52) U.S. Cl. CPC G05B 19/402; B21D 28/06; G05B 2219/35363

(57) ABSTRACT

An object arrangement apparatus includes a first area computing unit that computes a first area based on a distance of a second object translated with respect to a first object along a first direction so that a portion of the second object enters a concave portion of the first object, and a distance between one end and the other end of the first object in a first orthogonal direction; a second area computing unit that computes a second area based on a distance of the second object translated along a second direction so that the portion does not enter the concave portion, and a distance between one end and the other end of the first object in a second orthogonal direction; and an arrangement direction determining unit that determines the first direction as an object arrangement direction if the first area is smaller than the second area.

### CROSS-REFERENCE TO RELATED APPLICATIONS

This application is based on and claims priority under 35 USC 119 from Japanese Patent Application No. 2015-162378 filed. Aug. 20, 2015.

### BACKGROUND

(i) Technical Field

The present invention relates to an object arrangement apparatus.

(ii) Related Art

To manufacture a part configuring a mechanical product or the like, blanking of cutting out parts from a material such as a sheet, material has been executed. Also, to increase the ratio of the parts to be blanked to the material, that is, to increase the yield, tightly arranging as many parts as possible on the material at the timing of design, or so-called nesting has been executed.

### SUMMARY

According to an aspect of the invention, there is provided an object arrangement apparatus including a first arrangement unit that translates and arranges a second object with respect to a first object, the first object having an cater periphery including a concave portion, the second object having a shape equivalent to a shape of the first object, the second object being arranged so that a portion of the second object enters the concave portion of the first object; a first area computing unit that computes a first area on the basis of a distance by which the: second object is translated with respect to the first object along a first direction in which the second object is translated so that the portion of the second object enters the concave portion of the first object, and a distance between one end of the first object and the other end of the first object in a first orthogonal direction orthogonal to the first direction; a second arrangement unit that translates and arranges the second object with respect to the first object so that the portion of the second object does not enter the concave portion of the first object; a second area computing unit that computes a second area on the basis of a distance by which the second object is translated with respect to the first object along a second direction in. which the second object is translated so that the portion of the second object does not enter the concave portion of the first object, and a distance between one end of the first object and the other end of the first object in a second orthogonal direction orthogonal to the second direction; and an arrangement direction determining unit that determines the first direction as an object arrangement direction if the first area is smaller than the second area.

### BRIEF DESCRIPTION OF THE DRAWINGS

An exemplary embodiment of the present invention will be described in detail based on the following figures, wherein:

FIG. 1 is a general explanatory view of a design support system according to a first exemplary embodiment, of the present invention;

FIG. 2 is a block diagram showing functions of a controller of a client personal computer according to the first exemplary embodiment;

FIG. 3 is an explanatory view showing an image of a first object arranged on an imaginary plane according to the first exemplary embodiment;

FIG. 4 is an explanatory view showing a state of the first object when translated in a second movement direction according to the first exemplary embodiment;

FIG. 5 is an explanatory view showing vectors extending from each corner to the other corners formed at the first object according to the first exemplary embodiment;

FIG. 6 is an explanatory view showing a state in which “convex” or “concave” is set at each corner formed at the first object according to the first exemplary embodiment;

FIG. 7 is an explanatory view showing a state of the first object when translated in a first movement direction according to the first exemplary embodiment;

FIG. 8 is an explanatory view of a notification screen according to the first exemplary embodiment;

FIGS. 9A and 9B provide a flowchart of arrangement processing of an arrangement support program according to the first exemplary embodiment;

FIG. 10 is an arrangement diagram of products arranged by arrangement processing of a related art configuration;

FIGS. 11A and 11B are arrangement diagrams of the first object arranged by the arrangement processing according to the first exemplary embodiment, FIG. 11A being an arrangement diagram of the first object arranged along an arrangement direction corresponding to the minimum area, FIG. 1IB being an arrangement diagram of the first object arranged along the X-axis direction; and

FIGS. 12A and 12B are arrangement diagrams of a first object different from the first object in FIGS. 11A and 11B arranged by the arrangement processing according to the first exemplary embodiment, FIG. 12A being an arrangement diagram of the first object arranged along the first movement direction, FIG. 12B being an arrangement diagram of the first object arranged along the X-axis direction corresponding to the minimum area.

### DETAILED DESCRIPTION

A specific example for implementing the present invention (hereinafter, referred to an exemplary embodiment) is described below with reference to the drawings; however, the present invention is not limited to the following exemplary embodiment.

For easier understanding of the following description, in the drawings, it is assumed that the front-rear direction is the X-axis direction, the left-right direction is the Y-axis direction, and the up-down direction is the Z-axis direction; and directions or the sides indicated by arrows X, −X, Y, −Y, Z, and −Z respectively represent forward, rearward, rightward, leftward, upward, and downward, or front, rear, right, left, upper side, and lower side.

Also, in the drawings, it is assumed that a symbol in which “.” is written in “◯” represents an arrow directed from the back side to the front, side of the paper face, and a symbol in which “x” is written in “◯” represents an arrow directed from the front side to the back side of the paper face.

In the following description with reference to the drawings, illustration of members other than members required for the description is occasionally omitted for easier understanding.

### First Exemplary Embodiment

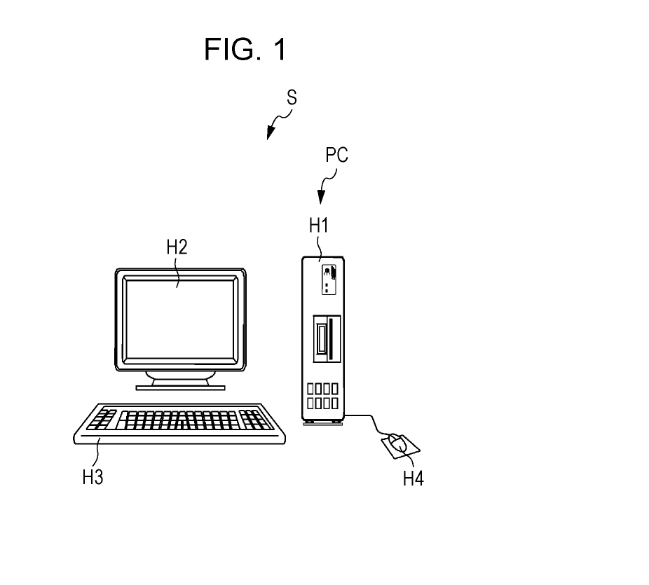

FIG. 1 is a general explanatory view of an arrangement support system according to a first exemplary embodiment of the present invention.

In FIG. 1, an arrangement support system S includes a client personal computer PC serving as an example of an object arrangement apparatus. The client personal computer PC has a function as a device for creating an arrangement diagram for an object. It is to be noted that the client personal computer PC in the first exemplary embodiment is configured of a computer device serving as an example of an electronic computer.

The client personal computer PC in the first exemplary embodiment includes a computer body H1 serving as an example of an electronic computer body. A display H2 serving as an example of a display device is connected to the computer body H1. Also, a keyboard H3 and a mouse H4 serving as examples of an input device are connected to the computer body H1. The computer body H1 includes a hard disk (HD) drive serving as an example of a memory device (not shown), and a compact disc (CD) drive serving as an example of a reading device for a storage medium.

### Description for Controller in First Exemplary Embodiment

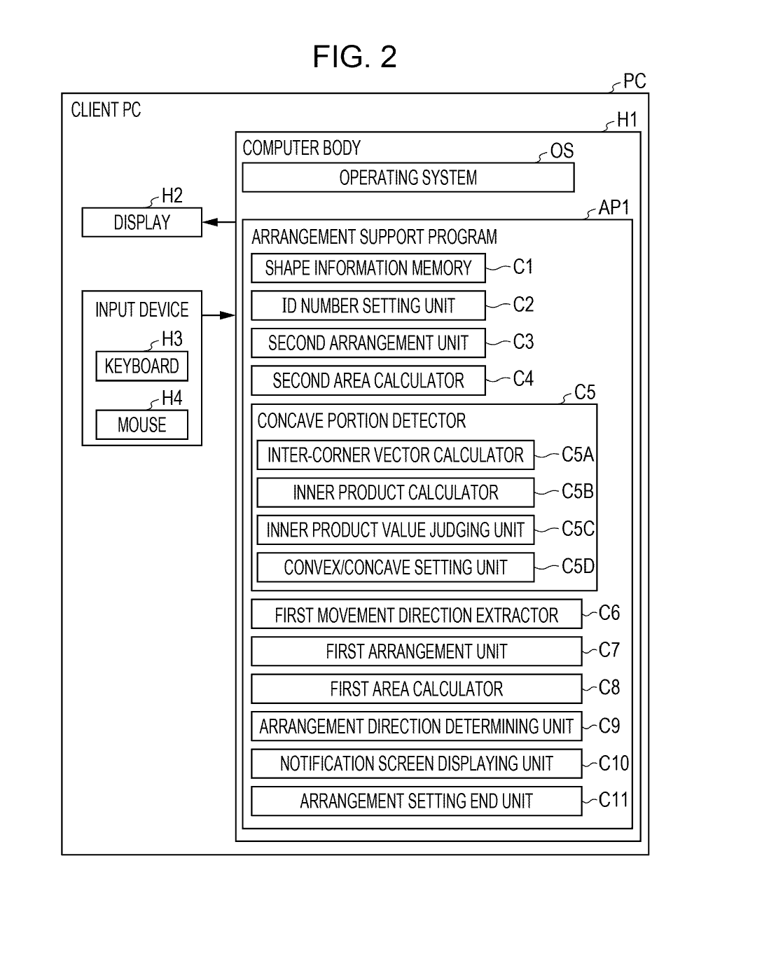

FIG. 2 is a block diagram showing functions of a controller of the client personal computer according to the first exemplary embodiment.

### Description for Controller of Client Personal Computer PC

In FIG. 2, the computer body H1 of the client personal computer PC includes an input/output (I/O) interface. The I/O interface inputs and outputs a signal with respect to an external device, and adjusts an input/output signal level. Also, the computer body HI includes a read only memory (ROM). The ROM stores, for example, a program for executing required processing, and data.

Also, the computer body Hi includes a random access memory (RAM). The RAM temporarily stores required data. Also, the computer body H1 includes a central processing unit (CPU). The GPU executes processing corresponding to the program stored in the hard disk or the like. Also, the computer body H1 includes a clock oscillator.

The client personal computer PC may realize various functions by executing the program stored in the hard disk, ROM, etc.

The hard disk of the client personal computer PC stores an operating system OS serving as system software. The operating system OS controls basic operation of the computer device.

Also, the hard disk of the client personal computer PC stores an arrangement support program AP1 serving as an example of an object arrangement program. The arrangement support program AP1 executes object arrangement processing.

Also, the hard disk of the client personal computer PC stores application programs (not shown), such as word processing software serving as document creating software and e-mail transmitting and receiving: software.

Hereinafter, respective functions (control units) of the arrangement support program AP1 except for the operating system OS and the application programs (not shown), which are known, are described.

### Arrangement Support Program AP1

In the following drawings, first objects have different shapes depending on the contents of description in the respective drawings, and hence the shapes are not necessarily the same.

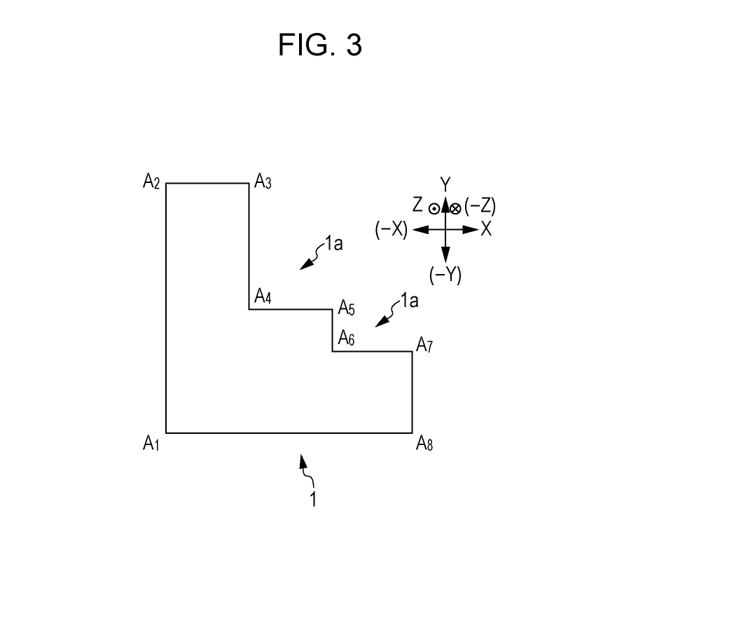

FIG. 3 is an explanatory view showing an image of a first object arranged on an imaginary plane according to the first exemplary embodiment.

### C1: Shape Information Memory

A shape information memory C1 stores shape information relating to the shape of a first object. The shape information memory C1 in the first exemplary embodiment stores shape information relating to the shape pattern of the first object on a pattern basis. In the first exemplary embodiment, as the shape information corresponding to the shape pattern of a target object 1 serving as an example of the first object, the position of a corner formed at the target object 1 and the distance between corners are stored. To be specific, for an example of the shape pattern in the first exemplary embodiment, as shape information associated with the target object 1, corners included in the target object 1, distances between the corners, and a region enclosed by the outer periphery of the target object 1 are stored.

### C2: ID Number Setting Unit

An identification (ID) number setting unit C2 sets identification (ID) numbers at the respective corners of the first object. As shown in FIG. 3, the ID number setting unit C2 in the first exemplary embodiment randomly selects a single point on the outer periphery among the corners formed in an image of the target object 1 arranged on the imaginary plane, and sets an ID number as a corner A₁. Then, the ID number setting unit C2 sets a corer ₂, a corner A₃, . . . , a A_{α-1}, a corner A_{α}at the respective corners of the target object 1 sequentially in the clockwise order from the corner A₁. In the first exemplary embodiment 1, when a concave portion 1a formed at the target object 1 is detected, the corner set as the corner A₁ is set as a start point A₁ on the target object 1 at which the detection is started.

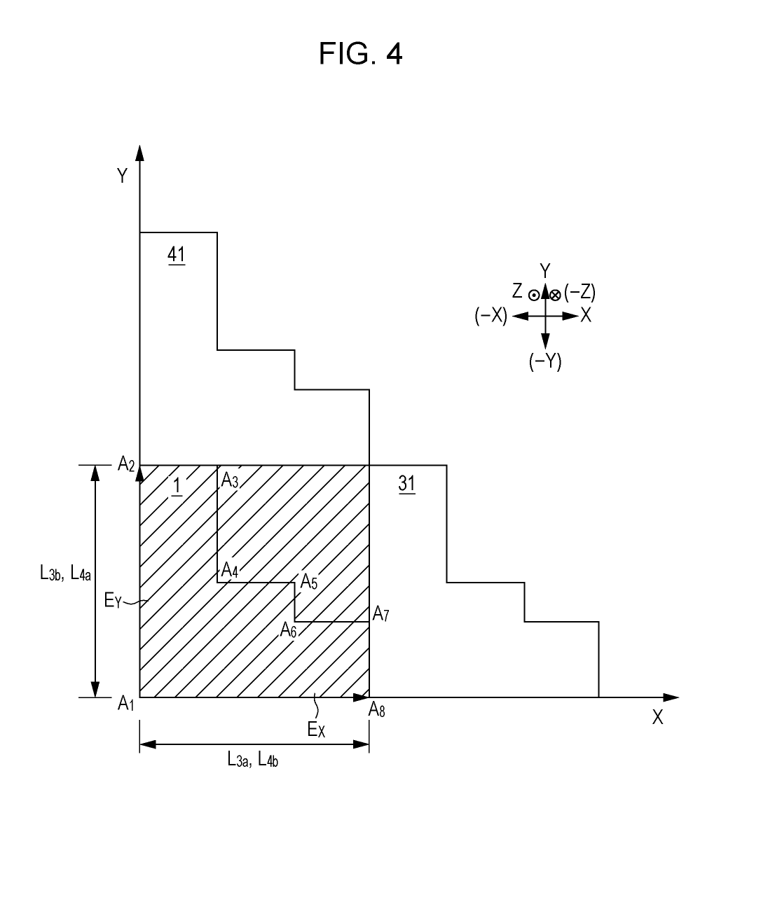

FIG. 4 is an explanatory view showing a state of the first object when translated in a second movement direction according to the first exemplary embodiment.

### C3: Second Arrangement Unit

A second arrangement unit C3 translates the first object along a predetermined second direction so that a second object having a shape equivalent to the shape of the first object does not enter a concave portion of the first object, and arranges the first object at a predetermined position. As shown in FIG. 4, the second arrangement unit C3 in the first exemplary embodiment translates the target object 1 along the X-axis and Y-axis directions as examples of the second direction and also examples of the second movement direction, toward the +X-axis direction and +Y-axis direction, and hence arranges adjacent objects 31 and 41 serving as examples of the second object. In the first exemplary embodiment, the target object 1 is translated along the X-axis and Y-axis directions until a portion of each of the adjacent objects 31 and 41 no longer overlaps a portion of the target object 1.

Also, with, the configuration in the first exemplary embodiment, to prepare for a die cutting operation of cutting out the target object 1 and the adjacent objects 31 and 41 from a base material, the target object 1 is further moved to have a sufficient allowance, that is, a margin in accordance with a gap of a predetermined length set between the target object 1 and each of the adjacent objects 31 and 41. In the first exemplary embodiment, the target object 1 is translated toward the +X-axis direction and the +Y-axis direction; however, it is not limited thereto. The target object 1 may be translated in directions other than the +X-axis direction and the Y-axis direction. For example, the target object 1 may be translated in the −X-axis direction and the +Y-axis direction, in accordance with the design and specification.

### C4: Second Area Calculator

A second area calculator C4 serving as an example of s second area computing unit calculates the area between the first object and the second object as a second area. The second area calculator C4 in the first exemplary embodiment calculates the area between the target object 1 and each of the adjacent objects 31 and 41, which are translated in the second movement directions by the second arrangement unit C3, as the second area.

To be specific, as shown in FIG. 4, a movement distance L₃ₐ corresponding to the distance between the corner A₁ of the target object 1 and the corner A₁ of the adjacent object 31, and a maximum width L_{3b} of the target object 1 in the Y-axis direction in the target object 1 are computed. Then, an area Eₓ that is an area of a region obtained by multiplying the movement distance L₃ₐ by the maximum width L_{3b} of the target object 1 is calculated as the second area. Also, an area E_{y} obtained by multiplying a movement distance L₄ₐ, which corresponds to the distance between the corner A₁ of the target object 1 and the corner A₁ of the adjacent object 41, by a maximum width L_{4b} of the target object 1 in the X-axis direct ion in the target object 1 is also calculated as the second

### C5: Concave Portion Detector

A concave portion detector C5 includes an inter-corner vector calculator C5A, an inner product calculator C5B, an inner product value judging unit C5C, and a convex/concave setting unit C5D, and detects a concave portion formed at the first object. The concave portion detector C5 in the first exemplary embodiment detects a corner forming a portion of a concave portion 1a among the corners formed at the target object 1 on the basis of the shape information stored in the shape information memory C1.

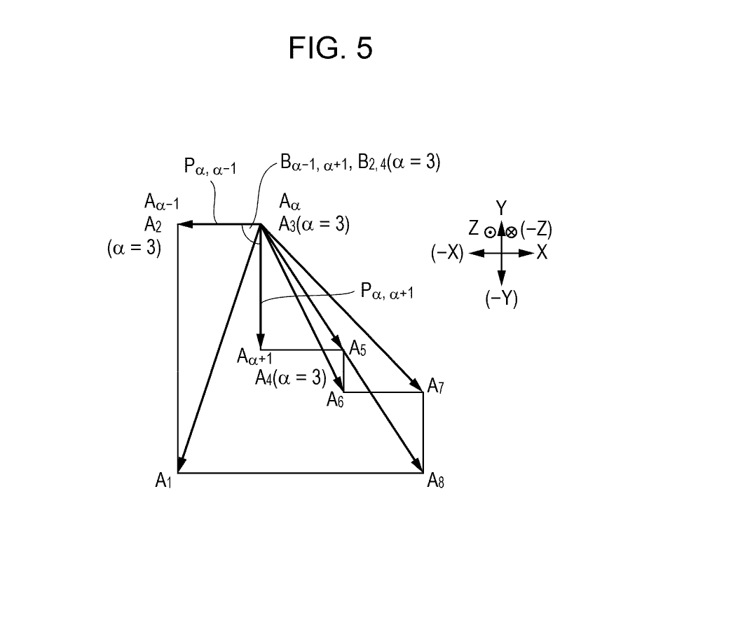

FIG. 5 is an explanatory view showing vectors extending from each corner to the other corners formed at the first object according to the first exemplary embodiment.

### C5A: Inter-Corner Vector Calculator

The inter-corner vector calculator C5A calculates vectors between each corner and the other corners formed at the first object. The inter-corner vector calculator C5A in the first exemplary embodiment calculates vectors P_{α,β}directed from each corner A_{α}to the other corners A_{β}of the first object having a number α of corners on the basis of the shape information memory C1 and the ID number setting unit C2, In the first exemplary embodiment, as shown in FIG. 5, vectors p directed from each corner A_{α}(1≦α≦8) to the other corners A_{β}(1≦β≦8) are calculated. Also, in the first exemplary embodiment, as each vector P_{α,β}a vector with a magnitude by the unit of 1 is calculated.

### C5B: Inner Product Calculator

The inner product calculator C5B calculates the inner products of the respective inter-corner vectors of the first object. The inner product calculator C5B in the first exemplary embodiment calculates inner product values as the inner product values of the respective vectors P_{α,β}of the target object 1, on the basis of the shape information of the target object 1 stored in the shape information memory C1 and the inter-corner vectors P_{α,β}calculated by the inter-corner vector calculator C5A.

### C5C: Inner Product Value Judging Unit

Among inner product values of a vector corresponding to one side of the first object and vectors extending from an end of the one side to the other corners, the inner product value judging unit C5C judges whether an inner product value of the vector corresponding to the one side and a vector corresponding to an adjacent side being adjacent to the one side is the minimum value or not. On the basis of the inner product values of the respective vectors P_{α,β}of the target object 1 calculated by the inner product calculator C5B, among inner product values B_{α-1,β}of a vector P_{α,α-1} directed from a corner to a corner A_{α}to a corner A_{α-1} and respective vectors P_{α,β}extending from the corner A_{α}to the other corners A_{β}in the target object 1, the inner product value judging unit C5C in the first exemplary embodiment judges whether an inner product value B_{α-1} of the vector P_{α,α-1} and a vector P_{α,α+1} directed from the corner A_{α}to a corner A_{α+1} is the minimum value or not.

To be specific, as shown in FIG. 5, in the target object 1, for example, among inner product values B_{2,β}of a vector P_{3, 2} directed from the corner A₃ to the upstream adjacent corner A_{Z} and respective vectors P_{3,β}directed from the corner A₃ to downstream respective corners A_{β}(1≦β≦8), it is judged whether an inner product value β_{2,4} of the vector P_{3,2} and a vector P_{3,4} directed from the corner A₃ to the corner A₄ is the minimum value or not.

### C5D: Convex/concave Setting Unit

The convex/concave setting unit C5D sets each corner formed at the outer periphery of the first object as one of a portion of the concave portion 1a and a portion of a convex portion of the first object. If the inner product value judging unit C5C judges that the inner product value B_{α-1,α+1} among the inner products B_{α-1,β}is not the minimum value, the convex/concave setting unit C5D judges that the adjacent corner A_{α+1} is a corner of the concave portion 1a, and sets the corner as being “concave.” Also, if the inner product value judging unit C5C judges that the inner product value B_{α-1, α+1} is the minimum value, the convex/concave setting unit C5D judges that the adjacent corner A_{α+1} is a corner of the convex portion, and sets the corner as being “convex.”

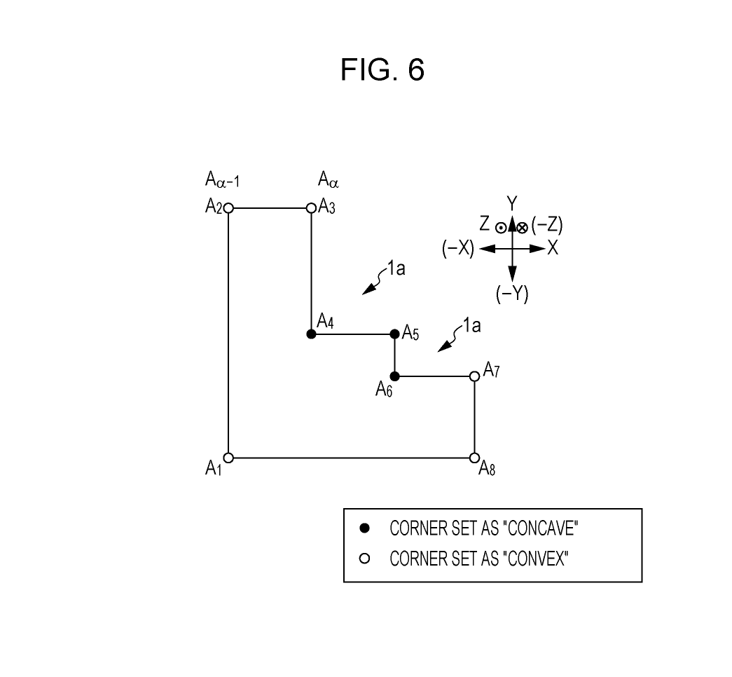

FIG. 6 is an explanatory view showing a state in which “convex” or “concave” is set at each corner formed at the first object according to the first exemplary embodiment.

To be specific, in the target object 1 shown in FIG. 5, among the inner product values B_{α-1,β}(1≦α,β≦8), the corners A₄ to A₆ are set as being “concave” as shown in FIG. 6 on the basis of judgment results of inner product values B_{3,5}, B_{4,6}, B_{5,7} the inner product values B_{α-1,α+1} of which each are judged as not being the minimum value. Also, the corners A₁, A₂, A₃, A₇, and A₈ are set as being “convex” on the basis of judgment results of inner product, values B_{1,3}, B_{2,4}, B_{6,8}, B_{7,1}, and B_{8,2} each judged as being the minimum value.

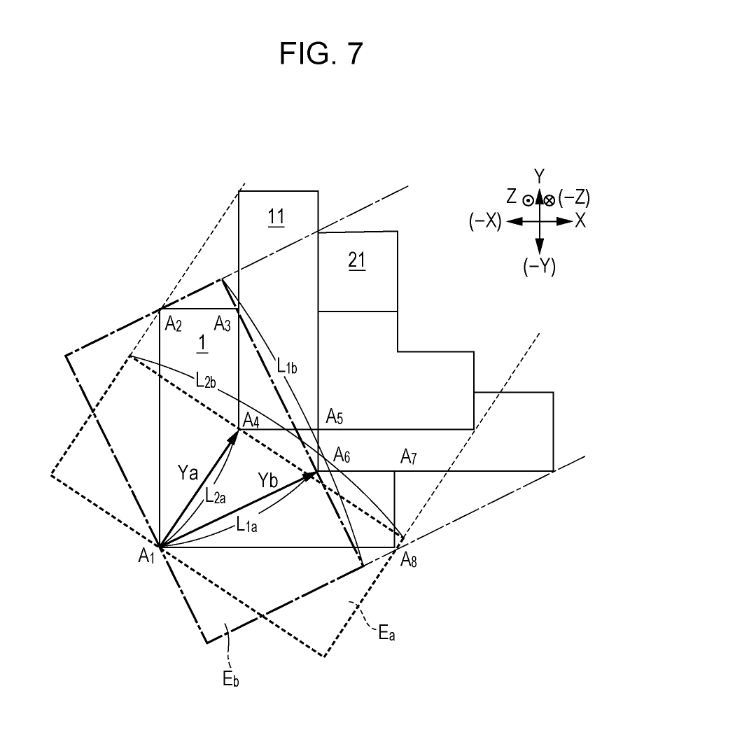

FIG. 7 is an explanatory view showing a state of the first object when translated in a first movement direction according to the first exemplary embodiment.

### C6: First Movement Direction Extractor

A first movement direction extractor C6 extracts the first movement direction as a direction in which the first object is moved so that a portion of the second object enters a concave portion of the first object, as an example of a first direction. The first movement direction extractor C6 extracts a direction directed from a corner with a minimum α among corners set as being “convex” of the target object 1 by the convex/concave setting unit C5D toward a corner set as being “concave” of the target object 1. To be specific, as shown in FIG. 7, an arrow Ya direction directed from the corner A₁ toward the corner A₄ of the target object 1, or an arrow Yb direction directed from the corner A₁ toward the corner A₆ of the target object 1 is extracted as the first movement direction. It is to be noted that, in the first exemplary embodiment, if the target object 1 has no corner set as being “concave,” the first movement direction is not extracted.

### C7: First Arrangement Unit

A first arrangement unit C7 translates the first object along the direction set in accordance with the concave portion of the first object, and arranges the first object at a predetermined position. The first arrangement unit C7 in the first exemplary embodiment translates the target object 1 along the first movement direction extracted by the first movement direction extractor C6 by a distance between a predetermined corner and another corner on the target object 1 stored in the shape information memory C1, and arranges the target object 1 as an adjacent object 11 or 21, serving as an example of the second object/ adjacent to the target object 1.

To be specific, as shown in FIG. 7, the target object 1 is translated along the first movement direction Ya until the corner A₁ of the target object 1 overlaps the corner and hence the adjacent object 11 is arranged. Also, the target object 1 is translated along the first movement direction Yb until the corner A₁ of the target object 1 overlaps the corner and hence the adjacent object 21 is arranged. In the first exemplary embodiment, when a corner set as being “convex” is moved onto a corner set as being “concave,” a portion of the target object 1 may overlap a portion of the adjacent object 11 or 21. In this case, the target object 1 is translated along the set first movement direction until the portion of the adjacent object 11 or 21 no longer overlaps the portion of the target object 1, and hence the adjacent object 11 or 21 is arranged. Accordingly, in the first exemplary embodiment, the adjacent object 11 or 21 is arranged in a state in which the portion of the adjacent object 11 or 21 enters the concave portion 1a formed at the target object 1. Also, in the configuration of the first exemplary embodiment, similarly to the second arrangement unit C3, the target object 1 is further moved to have a margin in accordance with a gap of a predetermined length set between the target object 1 and the adjacent object 11 or 21.

### C8: First Area Calculator

A first area calculator C8 as an example of a first area computing unit calculates an area between the first object and the second object, which is moved along the direction set in accordance with the shape of the first object, as a first area. The first area calculator C8 in the first exemplary embodiment calculates an area extending from an end of the target object 1 to an end of the adjacent object 11 or 21 along the first movement direction, as the first area.

To be specific, as shown in FIG. 7, a movement distance corresponding to the distance between the corner A₁ of the target object 1 and the corner A₁ of the adjacent object 11, and a maximum width L_{1b} of the target object 1 in an orthogonal direction orthogonal to the first movement direction Ya in the target object 1 are computed. Then, an area of a region obtained by multiplying the movement distance L₁ₐ by the maximum width L_{1b} of the target object 1 is calculated as a first area Eₐ. Also, an area obtained by multiplying a movement distance L₂ₐ, which corresponds to the distance between the corner A₁ of the target object 1 and the corner A₁ of the adjacent object 21, by a maximum width L_{2b} of the target object 1 in an orthogonal direction orthogonal to the first movement direction Yb in the target object 1 is also calculated as a first area E_{b}. In the configuration of the first exemplary embodiment, when three or more first movement directions are extracted for a target object, first areas Eₐ, E_{b}, E_{c}, . . . , corresponding to the target object and adjacent objects moved along the respective first movement directions are calculated.

### C9: Arrangement Direction Determining Unit

An arrangement direction determining unit C9 determines an arrangement direction being a direction in which the first object is arranged next to each other, among the movement directions. The arrangement direction determining unit C9 in the first exemplary embodiment determines the movement direction corresponding to the minimum area among areas calculated by the first area calculator C8 and the second area calculator C4, as an arrangement, direction. To be specific, as shown in FIGS. 4 and 7, the translation direction Ya corresponding to the first area Eₐ being the minimum area among the areas Eₐ, E_{b}, E_{X}, and E_{Y} computed by the first area calculator C8 or the second area calculator C4 is set as the arrangement direction.

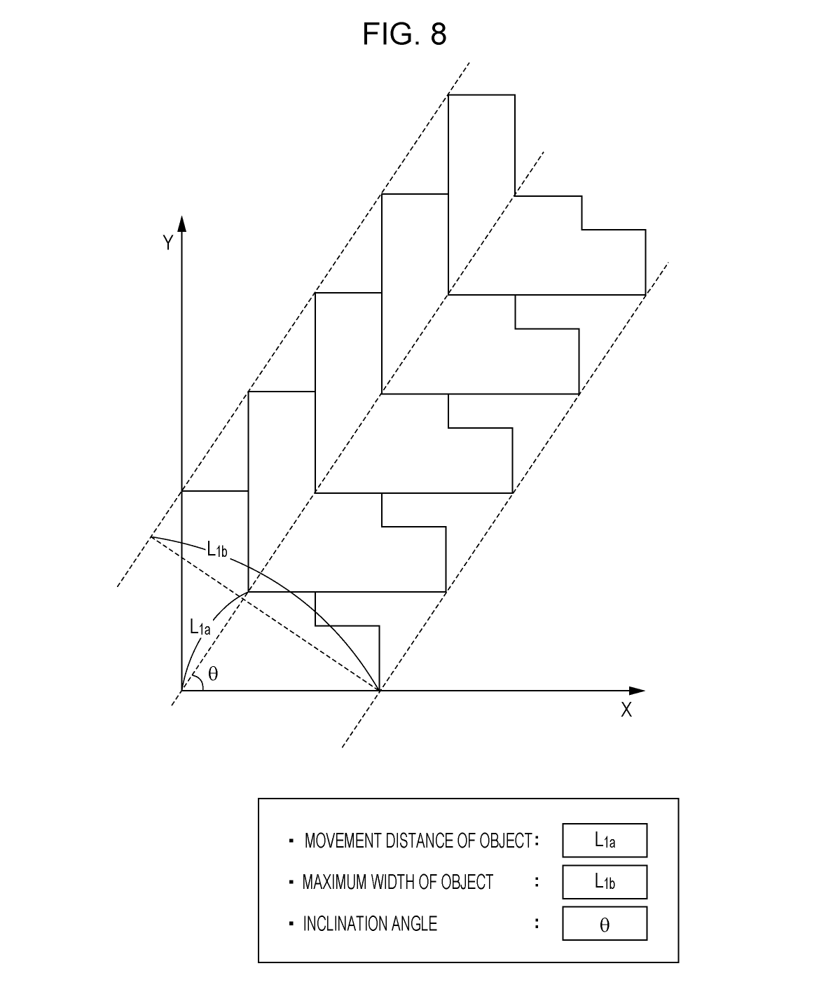

FIG. 8 is an explanatory view of a notification screen according to the first exemplary embodiment.

### C10: Notification Screen Displaying Unit

A notification screen displaying unit C10 displays a notification screen for notification about, arrangement information of the first object. The notification screen displaying unit C10 in the first exemplary embodiment displays a screen, for notification about the arrangement diagram of the target object 1 and the moved target object 1, the movement distance of the target object 1, the maximum width in the orthogonal direction of the target object 1, and the inclination angle θ of the arrangement direction with respect to the X-axis as arrangement information, on the display H2 when the target object 1 is moved in the arrangement direction. In the first exemplary embodiment, as shown in FIG. 8, the notification screen displaying unit C10 displays a screen for notification about the arrangement diagram of the target object 1 and the moved target object 1, the movement distance L₁ₐ of the target object 1, the maximum width L_{1b} in the orthogonal direction of the target object 1, and the inclination angle θ of the arrangement direction Ya with respect to the X-axis as arrangement information, on the display H2 when the target object 1 is moved in the arrangement direction Ya.

### C11: Arrangement Setting End Unit

An arrangement setting end unit C11 ends the object arrangement setting processing by the arrangement support system S when the notification screen displaying unit C10 displays the arrangement information on the display H2.

### Description for Flowchart in First Exemplary Embodiment

Next, the flow of the processing by the arrangement support program API of the client personal computer PC in the first exemplary embodiment is described by using a flowchart.

### Description for Flowchart of Object Arrangement Processing in First Exemplary Embodiment

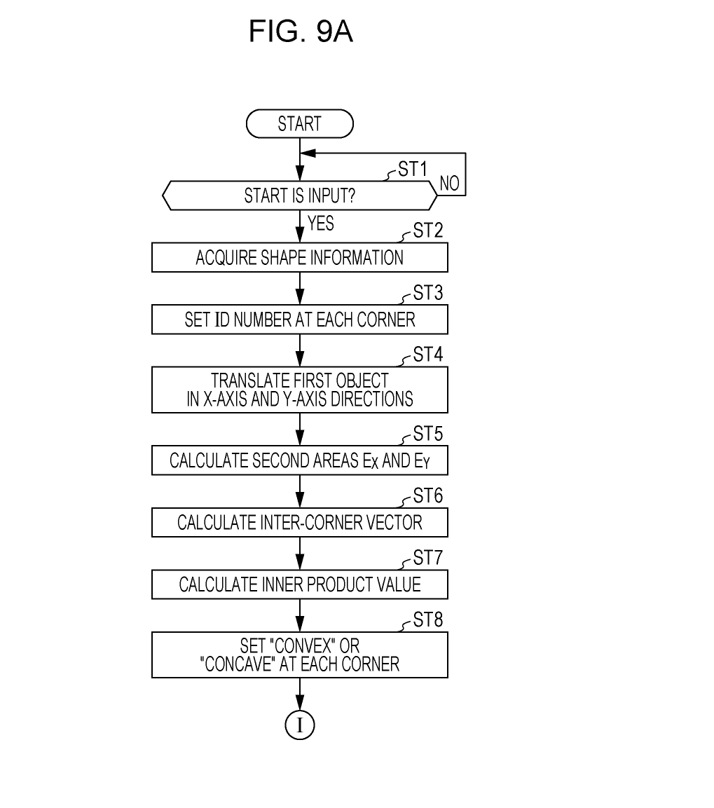

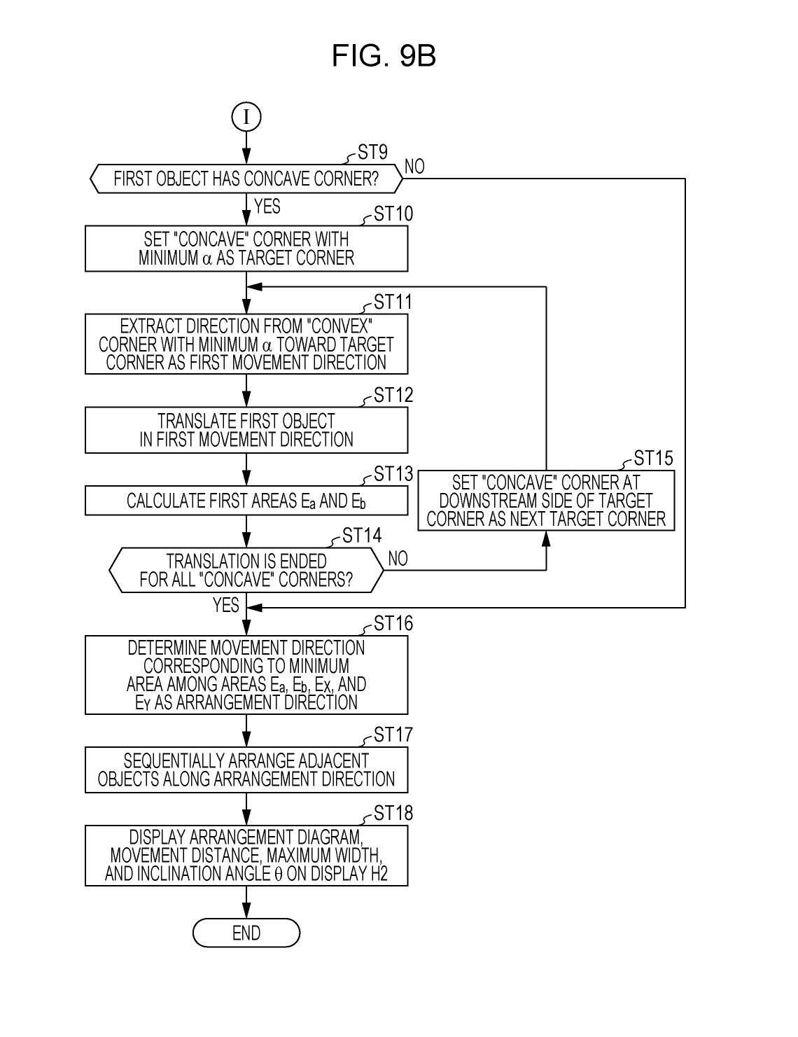

FIGS. 9A and 9B provide a flowchart :bf the arrangement processing of the arrangement support program according to the first exemplary embodiment.

Processing in each ST (step) of the flowchart in FIGS. 9A and 9B is executed according to a program stored in the ROM or the like of the controller. Also, this processing is executed in a multitasking manner in parallel to the other various processing of the controller, for example, drawing processing for a molded part.

The flowchart shown in FIGS. 9A and 9B is started when the client personal computer PC is turned on and then the arrangement support program AP1 is activated.

In ST1 in FIG. 9A, it is judged whether or not start is input by a user with the keyboard H3 or the mouse H4. If YES, the processing goes to ST2, and if NO, ST1 is repeated.

In ST2, the shape information of the target object 1 is acquired on the basis of the shape information memory C1. Then, the processing goes to ST3.

In ST3, among the corners formed at the target object 1, a single point on the outer periphery is randomly selected, and an ID number is set as the corner A₁. Then, ID numbers of the corner A₂, corner A₃, . . . , corner A_{α-1}, and corner A_{α}(1≦α≦8) are respectively set at the residual corners sequentially in the clockwise order from the corner A₁. Then, the processing goes to ST4.

In ST4, the target object 1 is translated along the X-axis and Y-axis directions until a portion of each of the adjacent objects 31 and 41 no longer overlaps a portion of the target object 1. Then, the processing goes to ST5.

In ST5, the second area E_{X} between the target object 1 and the adjacent object 31, and the second area E_{Y} between the target object 1 and the adjacent object 41 are calculated. Then, the processing goes to ST6.

In ST6, vectors P_{α,β}directed from the corner A_{α}to the other corners A_{β}(1≦β≦8) are calculated. Then, the processing goes to ST7.

In ST7, each inner product value B_{α-1,α+1} is calculated on the basis of the shape information of the target object 1 and the inter-corner vectors P_{α,β}. Then, the processing goes to ST8.

In ST8, each corner is set as being “concave” or “convex,” To be specific, among the inner product values B_{α-1,β}, if the inner product value B_{α-1,α+1} is judged as not being the minimum value, the corner A_{α+1} is set as being “concave,” and if the inner product value B_{α-1,α+1} is judged as being the minimum value, the corner A_{α+1} is set as being “convex.” Then, the processing goes to ST9.

In ST9, it is judged whether or not the corners formed at the target object 1 include a corner set as being “concave.” If YES, the processing goes to ST10, and if NO, the processing goes to ST16.

In ST10, among the corners set as being “concave,” the corner A_{α}with a being the minimum is set as a target corner used for extraction in the first movement direction. Then, the processing goes to ST11.

In ST11, a direction directed from the corner A_{α}with α being the minimum among the corners set as being “convex” of the target object 1 toward the target corner is extracted as the first movement direction. Then, the processing goes to ST12.

In ST12, the target object 1 is translated along the first movement direction. To be specific, the target object 1 is translated until a portion of the adjacent object 11 or 21 no longer overlaps a portion of the target object 1. Then, the processing goes to ST13.

In ST13, the second area Eₐ between the target object 1 and the adjacent object 11, and the second area B_{b} between the target object 1 and the adjacent object 21 are calculated. Then, the processing goes to ST14.

In ST14, it is judged whether or not translation is ended for all corners A_{α}set as being “concave.” If YES, the processing goes to ST16, and if NO, the processing goes to ST15.

In ST15, the corner located downstream in the clockwise direction of the target corner and set as being “concave” is set as the next target corner. Then, the processing returns to ST11.

In ST16, the movement direction corresponding to the minimum area among the calculated areas Eₐ, E_{b}, E_{X}, and E_{Y} is determined as an arrangement direction. Then, the processing goes to ST17.

In ST17, plural adjacent objects 11 are arranged along the arrangement direction with a predetermined gap interposed with respect to the target object 1. Then, the processing goes to ST18.

In ST18, as shown in FIG. 8, the arrangement diagram, the movement distance L₁ₐ, the maximum width L_{1b}, and the inclination angle θ of the arrangement direction with respect to the X-axis are displayed on the display H2. Then, the object arrangement processing is ended, and the processing returns to ST1.

### Operation of First Exemplary Embodiment

### Function of Object Arrangement Support Program AP1

In the arrangement support system S in the first exemplary embodiment having the above-described configuration, the arrangement support program AP1 is executed, and the object arrangement processing shown in FIGS. 9A and 9B is executed. When the shape information is acquired, as shown in FIG. 3, the ID numbers are set as the corner A₁, . . . , corner A_{α}(1≦α≦8) at the respective corners formed at the target object 1.

As shown in FIG. 4, the target object 1 with the ID numbers set is translated along the X-axis direction and the Y-axis direction until a portion of each of the adjacent objects 31 and 41 no longer overlaps a portion of the target object 1. Then, the second areas and E_{X} and E_{Y} between the target object 1 and the adjacent objects 31 and 41 are calculated. Also, as shown in FIG. 5, the vectors P_{α,β}directed from each corner A_{α}to the other corners A_{β}(1≦β≦8) are calculated, and the inner product value B_{α-1, α+1} is calculated on the basis of the vectors P_{α,β}and the shape information. Then as shown in FIG. 6, among the inner product values B_{α-1,β}, if the inner product value B_{α-1,α+1} is judged as not being the minimum value, the corner A_{α+1} is set as being “concave,” and if the inner product value B_{α-1,α+1} is judged as being the minimum value, the corner A_{α+1} is set as being “convex.”

If the target object 1 includes at least one corner set as being “concave,” as shown in FIG. 7, the target abject 1 is translated from the corner set as being “convex” and having α being the minimum toward the corner set as being “concave” until a portion of each of the adjacent objects 11 and 21 no longer overlaps a portion of the target object 1. Then, the second areas and Eₐ and E_{b} between the target object 1 and the adjacent objects 11 and 21 are calculated. In the first exemplary embodiment, the target object 1 is calculated for each corner set as being “concave.” The movement direction corresponding to the minimum area among the calculated areas Eₐ, E_{b}, E_{X}, and E_{Y} is determined as the arrangement direction.

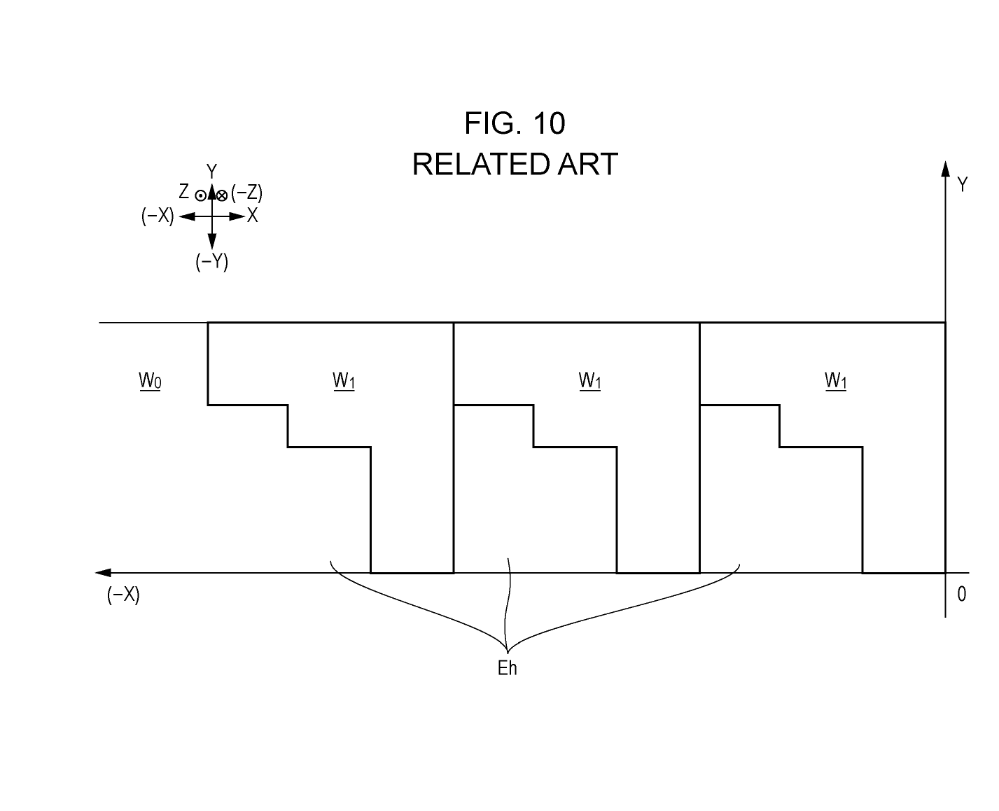

FIG. 10 is an arrangement diagram of products arranged by arrangement processing according to related art configuration.

In this case, with an example configuration of related art, a product group (W₁), which is configured of plural products having different shapes, sizes, and directions, is arranged from the right end toward the left in a tightly arranged manner. Then, a position at which the product group (W₁) is no longer detected is detected form the right end toward the left, and a region between the detected position and the right end is set as a minimum region where all product group (W₁), may be arranged.

However, with this configuration of related art, products are arranged next to each other from the right toward the left regardless of the shape, size, and direction of the product. The arrangement direction is limited to a certain arrangement direction regardless of the shape of the products.

Hence, although the area not to be used as a product is decreased if the products are arranged in a direction other than the direction from the right toward the left in accordance with the shape etc. of the products, the configuration of related art is not able to change the arrangement direction. Hence, in FIG. 10, when the product group (W₁) is cut out from a material (W₀), a region (Eh) to be discarded without cutting out a product is increased in the material (W₀).

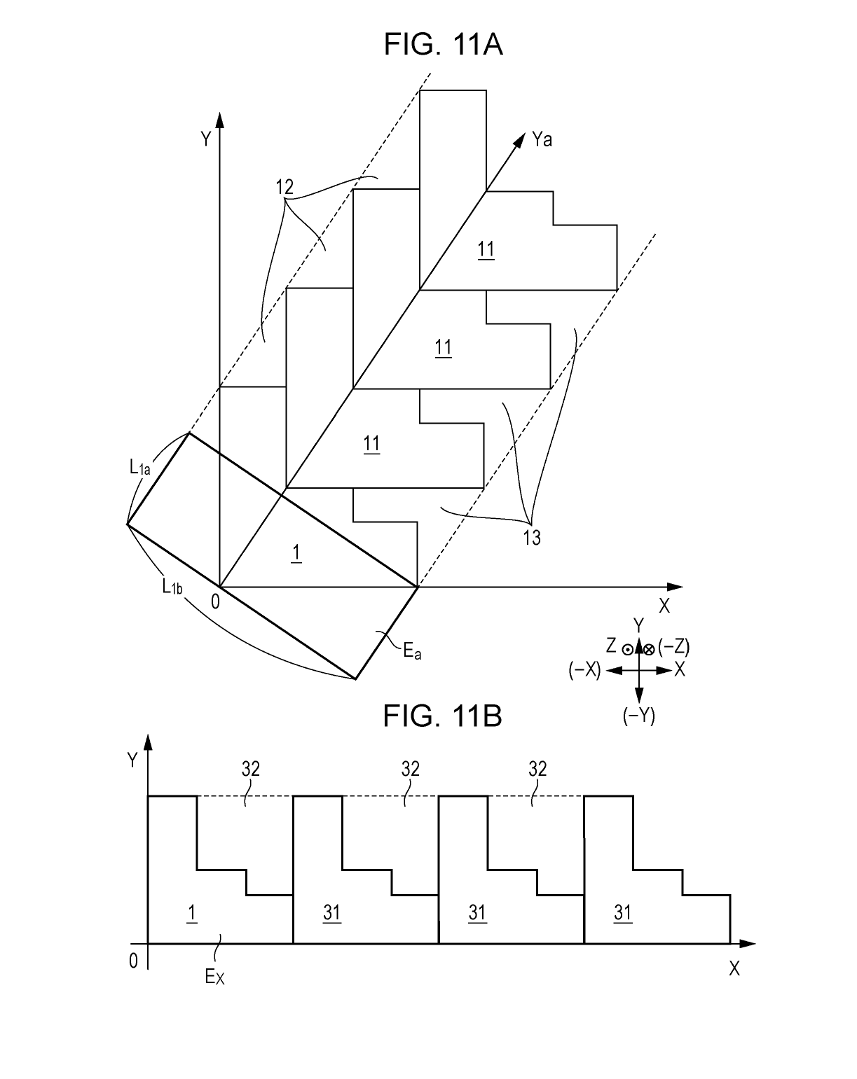

FIGS. 11A and 11B are arrangement diagrams of the first object arranged by the arrangement processing according to the first exemplary embodiment. FIG. 11A is an arrangement diagram of the first object arranged along the arrangement direction corresponding to the minimum area. FIG. 11B is an arrangement diagram of the first object arranged along the X-axis direction.

In contrast, with the configuration of the first exemplary embodiment, as shown in FIG. 7, the adjacent object 11 or 21 is arranged along the arrangement direction Ya or Yb if the first area Eₐ or E_{b} is the minimum area in the target object 1 having the concave portion 1a. In this case, the adjacent object 11 or 21 is arranged in the state in which a portion of the adjacent object 11 or 21 enters the concave portion 1a of the target object 1.

Hence, in the first exemplary embodiment, as is shown in FIG. 11A, the adjacent object 11 is arranged along the arrangement direction corresponding to the first area Eₐ being the minimum area, and the areas of regions 12 and 13 between the objects 1 and 11 may be decreased as compared with a region 32 between the objects 1 and 31 arranged along the X-axis direction shown in FIG. 11B.

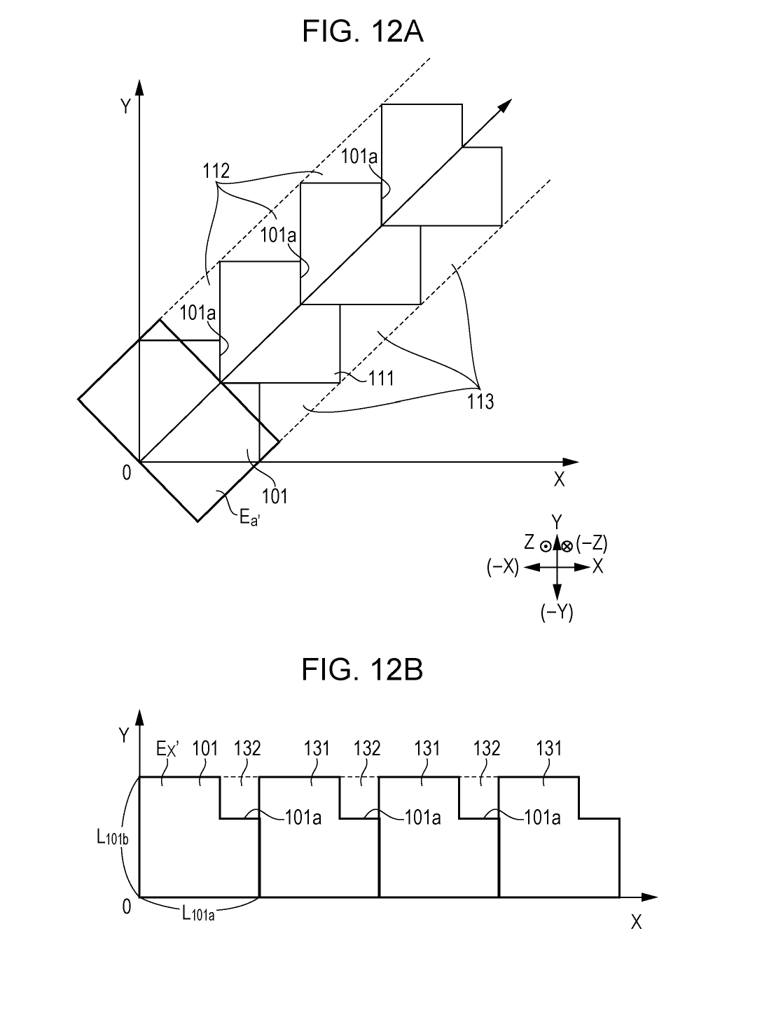

FIGS. 12A and 12B are arrangement diagrams of a first object different from the first object in FIGS. 11A and 11B arranged by the arrangement processing according to the first exemplary embodiment. FIG. 12A is an arrangement diagram of the first object arranged along the first movement direction. FIG. 12B is an arrangement diagram of the first object arranged along the X-axis direction corresponding to the minimum area.

Also, in the first exemplary embodiment, in a target object 101 serving as an example of the first object, an adjacent object 131 serving as an example of the second object is arranged along the X-axis direction if a first area E_{a′}shown in FIG. 12A is not the minimum area but a second area E_{X′}shown in FIG. 12B is the minimum area.

In this case, a region 132 not to be used as a product is decreased if the target object 101 is arranged without partial entrance of the adjacent object 131 into a concave portion 101a of the target object 101. Accordingly, in the first exemplary embodiment, the adjacent object 131 is arranged not in a state in which a portion of the adjacent object 131 enters the concave portion 101a formed at the target object 101. Hence, as shown in FIG. 12B, the adjacent object 131 is arranged with respect to the target object 101 along the arrangement direction corresponding to the second area E_{X′}being the minimum area.

Therefore, with the configuration in the first exemplary embodiment, the area of the region 132 between the objects 101 and 131 and not to be used as a product may be decreased as compared with regions 112 and 113 between objects 101 and 111 arranged along the first movement direction shown in FIG. 12A.

Hence, as compared with the configuration of related art in which the arrangement direction is not determined in accordance with the area Eₐ, E_{a′}, E_{b}, E_{X}, E_{X′}, or E_{Y}, with the configuration of the first exemplary embodiment, the areas of the regions 12 and 13, or 132 arranged between the objects 1 and 11 or between the objects 101 and 131 and not to be used for a product may be decreased to a minimum required area.

Also, in the first exemplary embodiment, when the area Eₐ or E_{x′}is calculated, the movement distance L₁ₐ or L₁₀₁ₐ corresponding to the distance between the corner A₁ of the target object 1 or 101 and the adjacent object 11 or 131, and the maximum width L_{1b} or L_{101b} of the target object 1 or 101 in the orthogonal direction orthogonal to the arrangement directions in the target object 1 or 101 are computed. The maximum width L_{1b} or L_{101b} corresponds to the width required for a base material from which the target object 1 or 101 and the adjacent object 11 or 131 are cut out. Also, the movement distance L₁ₐ or L₁₀₁ₐ corresponds to a rough length of a single product, and a required rough length of the base material may be detected from the movement distance L₁ₐ or L₁₀₁ₐ, and the required number of products. Accordingly, with the configuration of the first exemplary embodiment, even if the arrangement direction is inclined with respect to the X-axis direction or the Y-axis direction, the rough size of the required base material may be easily recognized by the user on the basis of the movement distance L₁ₐ or L₁₀₁ₐ, and the maximum width L_{1b} or L_{101b}.

Also, in the first exemplary embodiment, a margin is provided between the target object 1 or 101 and the arranged adjacent object 11 or 131. If a margin is not provided, when a cutting edge cuts out the object 1, 101, 11, or 131 by the die cutting operation, a boundary portion of the object 1, 101, 11, or 131 may be occasionally chipped more than, designed. Accordingly, in the first exemplary embodiment, as compared with a configuration without a margin, when the die cutting operation is executed, a possibility that the object 1, 101, 11, or 131 is not formed as designed may be decreased.

### Modifications

The exemplary embodiment of the present invention is described above; however, the present invention is not limited to the aforementioned exemplary embodiment, and may be modified in various ways within the scope of the present invention described in the claims. Modifications (H01) to (H09) of the present invention are exemplarily described below.

(H01) In the exemplary embodiment, the target object 1 shown in FIG. 3 and the target object 101 shown in FIGS. 12A and 12B are exemplarily described; however, it is not limited thereto. A target object formed in desirable shape and size may be used in accordance with design and specification.

(H02) In the exemplary embodiment, a gap with a predetermined length is provided between the target object and the adjacent object to prepare for the die cutting operation of cutting out the target object and the adjacent object from the base material by the first arrangement unit C7; however, it is not limited thereto. For example, as the thickness of the base material is increased, the length of the gap may be automatically increased. Alternatively, a user may manually change the length of the gap. The length of the gap between the target object and the adjacent object may be changed in accordance with design and specification.

(H03) In the exemplary embodiment, after the client personal computer PC is turned on and then the arrangement support program AP1 is activated, the object arrangement processing is started; however, it is not limited thereto. For example, registration application information and license agreement information may be transmitted and received between the client personal computer PC and a license server, and if the arrangement support system S obtains the license and then the arrangement support program AP1 is activated, the object arrangement processing may be started.

(H04) In the exemplary embodiment, the target object 1 or 101 is desirably further moved to have a margin in accordance with the gap of the predetermined length set between the target object 1 or 101 and the adjacent object 11 or 131. However, depending on the creation method of the target object 1 or 101, the target object 1 or 101 may be moved without a margin between the target object 1 or 101 and the adjacent object 11 or 131.

(H05) In the exemplary embodiment, the two directions of the X-axis and. Y-axis directions are set as the second movement directions serving as the examples of the second direction; however, it is not limited thereto. For example, only at least one of the X-axis and Y-axis directions may be set as the second movement direction. Alternatively, a direction inclined with respect to the X-axis direction or the Y-axis direction may foe previously set as the second movement direction.

(H06) In the exemplary embodiment, the direction directed from the “convex” corner toward the “concave” corner is set as the first movement direction; however, it is not limited thereto. For example, if plural “concave” corners are present, a direction directed from the “convex” corner toward a midpoint position of the “concave” corners may be set as the first movement direction.

(H07) In the exemplary embodiment, the corner forming the portion of the concave portion 1a or 101a is detected among the corners formed at the target object 1 on the basis of the shape information storing the positions of the corners formed at the target object 1 and the distances between the corners; however, it is not limited thereto. For example, convex/concave information in which “convex” or “concave” is associated with each corner of the target object 1 may be previously stored, and the detection of “convex” or “concave” of each corner may be omitted. Alternatively, as a configuration that detects “convex” or “concave” for each corner, a convex polygon circumscribing the target object 1 or a circumscribed circle is obtained, and a corner not present on the circumscribed polygon or the circumscribed circle among corners on the outer periphery of the target object 1 may be detected as a “concave” corner. Still alternatively, a projection image of a target object may be created once, the image may be analyzed, and a corner forming a portion of a concave portion may be detected.

(H08) In the exemplary embodiment, the direction directed toward the “concave” corner while the start point is at the corner with the minimum α set as being “convex” is set as the first direction; however, it is not limited thereto. Setting may be desirably executed, such as randomly setting the start point.

(H09) In the exemplary embodiment, the first direction directed from the “convex” corner formed at the lower left of the target object 1 toward the “concave” corner is exemplarily described; however, it is not limited thereto. For example, a direction directed from a “convex” corner formed at any of the lower right, upper right, and upper left toward a “concave” corner may serve as the first direction.

The foregoing description of the exemplary embodiment of the present invention has been provided for the purposes of illustration: and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An object arrangement apparatus comprising:
a first arrangement unit that translates and arranges a second object with respect to a first object, the first object having an outer periphery including a concave portion, the second object having a shape equivalent to a shape of the first object, the second object being arranged so that a portion of the second object enters the concave portion of the first object;
a first area computing unit that computes a first area on the basis of a distance by which the second object is translated with respect, to the first object along a first direction in which the second object is translated so that the portion of the second object enters the concave portion of the first object, and a distance between one end of the first object and the other end of the first object in a first orthogonal direction orthogonal to the first direction;
a second arrangement unit that translates and arranges the second object with respect to the first object so that the portion of the second object does not enter the concave portion of the first object;
a second area computing unit that computes a second area on the basis of a distance by which the second object is translated with respect to the first object along a second direction in which the second object is translated so that the portion of the second object does not enter the concave portion of the first object, and a distance between one end of the first object and the other end of the first object in a second orthogonal direction orthogonal to the second direction; and
an arrangement direction determining unit that determines the first direction as an object arrangement direction if the first area: is smaller than the second area.

2. The object arrangement apparatus according to claim 1, wherein the first arrangement unit and the second arrangement unit each arrange the first object and the second object so that, when the second object is translated with respect to the first object, a gap being the narrowest among gaps between the first object and the second object has a predetermined length or larger.
